(19) United States
(12) Patent Application Publication
(10) Pub. No.: US 2018/0251985 A1
(43) Pub. Date: Sep. 6, 2018

(54) Covering Panel Comprising a Lighting System

(71) Applicant: BEAULIEU INTERNATIONAL GROUP NV, Waregem (BE)

(72) Inventors: Frans VAN GIEL, Kortrijk (BE); Christophe Dominique René HAEGEMAN, Ternat (BE); Pol LOMBAERT, Nazareth (BE)

(21) Appl. No.: 15/758,034

(22) PCT Filed: Sep. 7, 2016
(86) PCT No.: PCT/EP2016/071071

§ 371 Date: Mar. 7, 2018

(30) Foreign Application Priority Data
Sep. 7, 2015 (EP) 15184107.9

(51) Int. Cl. E04F 13/08; E04F 15/02; F21V 33/00

(52) U.S. Cl. CPC E04F 13/08; E04F 15/02; F21Y 2115/10; E04F 2290/026; F21V 33/006

(57) ABSTRACT

The present invention provides a covering panel, such as a floor covering panel, a wall covering panel or a ceiling covering panel, comprising: (i) a top layer, (ii) a substrate, and (iii) a lighting system comprising a plurality of light units wherein the lighting system is situated between said top layer and said substrate.

### TECHNICAL FIELD

The present invention relates to the field of covering panels such as floor coverings, wall coverings and ceiling coverings. More specifically, the invention is directed to covering panels comprising a lighting system.

### INTRODUCTION

It is an object to provide panels which allow for controllable lighting through use of light units. Such panels can be applied i.e. for reasons of design, illumination of specific design elements, or for temporarily displaying selected information. Such panels can be usefully employed in areas where the information to be displayed is depending on a certain period of time and/or location. To this aim, i.e. flooring panels have been developed comprising power supply and electrical and mechanical connectors.

I.e., WO 2011/036614 describes a technology whereby a partially translucent PVC or laminate tile covers a LED-based lighting system. More specifically, a flooring product is described comprising a floor layer, adapted to support a user of said flooring product, a first conducting layer, a second conducting layer, and an insulating layer sandwiched between the conducting layers. Each conducting layer extends across a surface area of the flooring product, and the first conducting layer comprises at least one hole to provide access to at least one electrical component arranged in electrical contact with said second conducting layer, and thereby allow electrical connection between the first conducting layer and said electrical component.

WO 2009/087588 describes a light emitting floor panel whereby a series of LEDs are provided in an insulating layer with electrical connections to a first and a second conductive layer. Electrical connections are provided by wire-bonding, soldering, electrically conductive foils or metal wire meshes. Two or more panels can be positioned to provide electrical contact between the respective conductive layers.

The state of the art does, however, not report on covering panels which allow for ease of installation, have high mechanical strength and/or high dimensional stability, while ensuring control and high performance of the lighting system in the covering panel. It is thus also an object of the present invention to provide covering panels which can be mechanically and electrically connected to form a surface covering without loss of properties such as mechanical strength and dimensional stability.

### SUMMARY OF THE INVENTION

The current invention provides in a solution for at least one of the above mentioned problems by providing covering panels comprising a lighting system, as described in claims 1-14.

In a first aspect, the present invention provides a covering panel, such as a floor covering panel, a wall covering panel or a ceiling covering panel, comprising:

i. a top layer,

ii. a substrate, and

iii. a lighting system comprising a plurality of light units wherein the lighting system is situated between said top layer and said substrate.

This is advantageous because the lighting system can be supported by a substrate and be protected by a top layer.

### DETAILED DESCRIPTION OF THE INVENTION

In a first aspect, the present invention provides a covering panel, such as a floor covering panel, a wall covering panel or a ceiling covering panel, comprising:

i. a top layer,

ii. a substrate, and

iii. a lighting system comprising a plurality of light units wherein the lighting system is situated between said top layer and said substrate.

This is advantageous because the lighting system can be supported by a substrate and be protected by a top layer. The substrate provides the desired geometry for the covering panel and functions as a carrier for the lighting system which is affixed in or on top of said substrate. Accordingly, a predetermined spreading of the light units of the lighting system can be achieved, while also providing for the desired dimensions and dimensional stability of the covering panel. The dimensional stability of the covering panel reassures that the electric connections between neighbouring panels can be maintained. The top layer provides protection against resulting damages and may be able to support any objects or persons onto said covering panel.

1. Covering Panel

The present invention relates to a covering panel. Several covering panels can be assembled together for example by mechanical connections to form a surface covering such as a floor, a wall or a ceiling. The covering panel of the present invention can be a floor panel, a wall panel, a ceiling panel, and the like. The covering panel can be used essentially in any room in a house or work environment, including the kitchen, bathroom, living room, dining room, recreation room, garage, and outside living spaces, such as a porch, deck, shed, terrace, summerhouse, and the like.

The covering panel can have any suitable length and/or width and can be provided in any shape, such as a rounded shape and a polygonal shape (triangle, rectangle, square, pentagon, hexagon, heptagon or octagon). Preferably, the covering is provided in the shape of a square or e.g. a rectangle. The panels of the present invention can also have a three dimensional shape, such as a corner-type shape which can usefully be employed as a panel connection between surfaces which are perpendicular to each other for use in, for example, wall and ceiling coverings, and even stairs. In one preferred embodiment, the panel can be formed as a rectangle with two pairs of opposing sides wherein the pairs of sides can be the same or different in length relative to each other. In one example, the panel is rectangular. The rectangular panel can have opposite shorter sides having a width, for example, of from 10 cm to 50 cm, preferably from 10 cm to 30 cm or other widths, and opposite longer sides having a length, for example, of from 50 cm to 300 cm, preferably from 80 cm to 250 cm or other lengths. In one example, the panel also may be square shaped (e.g. a tile). The sizes of the present panels are not necessarily limited with respect to larger sizes other than possibly by practical considerations such as respect to handling, etc. The smaller sizes of the panels should adequately allow for the formation and use of the profiled edges on the panel. In some examples, the panels have square shapes with a side length of from 20 cm to 100 cm, preferably from 25 cm to 80 cm, more preferably from 30 cm to 60 cm, or other side lengths.

2. Substrate

The substrate may be wood-based (including e.g. a fiberboard (MDF, HDF), or a particle board). The substrate may also be made of, or at least comprising a layer of, synthetic material and optionally a filler material. The substrate may also comprise composite materials such as wood-plastic composites (WPC), referring to a composite structure comprising a wood-based material and a polymer-based material, which optionally may be foamed. A substrate according to current invention preferably comprises a core with a top surface and bottom surface as well as side surfaces.

In one embodiment, the substrate is comprised of one or more layer(s) of a polymeric material. The polymeric material can be, for example, a thermoplastic polymer, a thermoset polymer, or blends of polymers. Said one or more layer(s) may be the same or different with respect to composition and/or physical properties.

The substrate may include one or more additives known in the art such as fillers, plasticizer or stabilizers. Other ingredients can be present in the substrate or in at least one layer, such as flame retardants, antistatic agents, antimicrobial additives, processing aids, dispersion additives, lubricants, colorants, modifying resins, cross-linking agents, antioxidants, foaming agents, tackifiers, and/or other conventional additives commonly used in substrates for coverings.

In a preferred embodiment, the substrate has a thickness of 1 mm to 25 mm. In one embodiment, the substrate has a thickness of 5 mm to 25 mm, and more preferably of 8 mm to 20 mm. Such covering panels can be usefully employed for ceiling panels. In one embodiment, the substrate has a thickness of 5 mm to 15 mm, and more preferably of 8 mm to 10 mm. Such covering panels can be usefully employed for wall panels. In one embodiment, the substrate has a thickness of 2.0 mm to 6.0 mm, and more preferably with a thickness of 3.0 mm to 5.0 mm. Such covering panels can be usefully employed, i.e. for floor panels where requirements for mechanical strength are high, but where the specific surface weight (gsm) of the panel is preferably low in order to allow for an environmentally friendly transport and ease during installation.

3. Top Layer

The top layer can be a single layer but is preferably multi-layered and is at least partially translucent, and preferably comprises a synthetic material. The top layer can be translucent over the entire surface of the surface of the covering panel or can be translucent in selected areas, i.e. areas corresponding to the position of light units. The top layer is provided on top of the lighting system. The top layer may comprise a wear layer and optionally a protective layer on top of the wear layer. The top layer(s) may comprise PVC, olefins, urethane, ionomer, acrylic, polyester, thermoplastic polyolefin (TPO), thermoset polyurethane (TPU), or other materials conventionally used for this type of layer(s) or materials. The protective layer may comprise a thermally cured system such as water based polyurethane dispersion system, water based acrylic, or vinyl emulsion coating, or a radiation cured coating system such as urethane epoxy or polyester acrylates, or other materials conventionally used for this type of layer or materials.

In one preferred embodiment, the substrate has a top surface and located or affixed on the top surface of the substrate is a print layer. The print layer has a top surface and a bottom surface. Affixed onto the top surface of the print layer is a wear layer having a top surface and a bottom surface. An underlay layer optionally can be located and affixed between the bottom surface of the print layer and the top surface of the substrate.

3.1 Décor

In a preferred embodiment, the top layer comprises a décor provided on top of said lighting system. The term “décor” refers to a layer of material which is embodied to provide a visual effect. The décor may be solely comprised of an ink layer or may comprise an underlay which is selected to provide a strong adhesion to said lighting system and/or said top surface of said substrate. The décor may be provided partially or entirely on top of said lighting system. Said décor may be wood veneer or paper with a (printed) décor. Said décor may be solely comprised of an ink layer.

In a preferred embodiment, the décor is a print pattern which is printed by means of a digital printer.

The print pattern may be directly applied on top of said lighting system. The print pattern may be applied by laser printing, inkjet printing, or a combination thereof. This allows a fast and accurate printing.

Any suitable ink such as water-based inks, UV-curable inks or powder inks may be used. However, UV-curable inks are preferred.

3.2 Wear Layer

The top layer may comprise a wear layer. Preferably, said wear layer is substantially provided over the décor, and more preferably over the entire surface of said décor.

The wear layer may be comprised of any suitable material known in the art, such as a polymeric film or overlay paper. In one embodiment, the wear layer is comprised of one or more layers comprising a polymeric material, such as a thermoplastic and/or thermoset material. In one embodiment, the wear layer comprises a transparent polyvinyl chloride layer. Other examples of the wear layer include, but are not limited to, acrylic polymers, polyolefins, polyurethane, and the like. The wear layer is translucent and preferably transparent. Examples of such wear layers can be found in, for example, U.S. Pat. No. 4,333,987, U.S. Pat. No. 4,180,615, U.S. Pat. No. 4,393,187 and U.S. Pat. No. 4,507,188. The wear layer top coat can be a hard, thermoset, radiation-curable acrylate monomers and/or oligomers having a glass transition temperature (Tg) of greater than about 50° C. The wear layer may further be a water based, solvent based, radiation-curable, non-radiation curable, UV-curable or non-UV curable system. I.e., the wear layer material may comprise acrylics, acrylates, urethanes, epoxides or vinyls, and/or blends thereof.

The wear layer may further comprise other components, such as wood fibres or wood particles, fillers, plasticizer, stabilizers, flame retardants, antistatic agents, wear resistant agents, antimicrobial additives, processing aids, dispersion additives, lubricants, modifying resins, cross-linking agents, antioxidants, foaming agents, tackifiers, etc. In one embodiment, the wear layer comprises light scattering particles.

4. Lighting System and Light Units

The term “lighting system” refers to one or more light units or light components which are connected, or which are at least connectable, with each other through a network of electric connections to form an electric network. In said network, each light unit is connected with one pole to an anode and with a second pole to a cathode. The network can be connected to one or more sources of electric energy.

The term “light unit” refers to an electric component which is configured to emit light. The emitted light can be of distinctive wavelengths or can comprise light of multiple wavelengths.

According to a preferred embodiment of the invention, the light units are LEDs, organic LEDs (OLEDs) and more specifically LED films or OLED films, dielectric barrier discharge lamps, gas discharge lamps, high intensity discharge lamps, incandescent lamps, fluorescent lamps or high pressure sodium lamps. More preferably, said light units are LEDs or OLEDs since such lighting component dissipate a limited amount of heat compared to alternative lighting sources. Depending on the intensity and wavelength spectrum of light which is desired for a specific application, a selection can be made among these types of light units.

In a preferred embodiment, the lighting system comprises two or more sets of light units. The light units can be connected randomly, but are preferably connected in a structured fashion. The light units within the electric network may be electrically connected in series or may be electrically connected in parallel. Additionally, a part of the light units may be electrically connected in series, while another part of the light units is connected in parallel.

The number of light units per m² may for instance be in the order of 1 to 400, such as 4 to 100, though covering panels with more or even with less light units per square meter are also embodied. Note that the distribution of the light units in the covering panel may be uniform or may vary in different areas. Also, the light units may be provided to form patterns.

In a preferred embodiment, the lighting system comprises two or more subsets of light units. As such, each set of light units can be selected for reasons of light intensity or wavelength of light, in order to provide a supply of light which is tailored towards specific lightening needs. The subsets may have light units arranged in an elongated shape with subsets arranged parallel. For instance, two or more subsets of lighting points may be provided as elongated subsets, like in the form of rows of light units. In this way, a covering panel may be provided wherein strips may provide light with different spectral distributions. In principle, also non-symmetric arrangements of the light units in a subset or of the pluralities of subsets in said covering panels may be possible. The two or more subsets may be independently controllable. An advantage of multiple subsets is that dedicated parts of an object may be illuminated with a “high” spatial resolution. With about the same resolution, a certain wavelength or certain wavelengths of the light may be selected and provided at the right position. Hence, the covering panel in an embodiment may comprise “colour pixels”, that can be switched on and off, by which the spectral intensity distribution of the emitted light can be varied.

4.1 Electric Connections

In one embodiment, the invention provides a covering panel according to the first aspect of the invention, whereby said substrate comprises a plurality of cavities for hosting a plurality of light units. Preferably, each cavity comprises one, single light unit. The substrate may comprise a plurality of conduits between said plurality of cavities for providing electric connectivity between said plurality of hosted light units. This is advantageous, since the light units are provided within the substrate and are accordingly more protected towards external pressure on the covering panel and thus on said light units. For example, the light units may be connected with each other via an electric connection connecting a first side of said cavities, i.e. the bottom side of said cavities, while said light units may be connected with each other via an electric connection connecting a second side of said cavities, i.e. the top side of said cavities. As such, each light unit may be connected electrically to allow an electric flow through each light unit upon connection to an electric source. Also, said configuration allows a user to cut through a panel to allow for on location dimensioning, without loss of functional activity of said covering panel.

In another embodiment, the light units are provided within an insulating layer. Said insulating layer is advantageous to allow a separation between a first and a second network of electric connections connecting said plurality of light units. Such an electric insulation is mandatory for an optimal working mode of the covering panel. Preferably, said insulating layer is comprised of a polymer material such as polyvinylchloride, polyolefins, urethane, acrylic, polyester, thermoplastic polyolefin (TPO), thermoset polyurethane (TPU) and more preferably polyvinylchloride. Alternatively, said insulating layer may comprise a silicon-base polymeric material. Said insulating material may be a thermoplastic material or a thermoset material. Preferably, said polymer material is a resilient material for providing a degree of elasticity and is a transparent or at least partially translucent material. The light units may have a first electric connection protruding from a first surface of said insulating layer and a second electric connection protruding from a second surface of said insulating layer. Such a configuration whereby two sets of electric connections protrude from a surface of the insulating layer allows to provide two separate networks of electric connections, in order to allow for an electric current through each light unit upon connection to an electric source. Said electric connections can extend from the top and/or bottom surface of said insulting layer and/or can extend from the side surfaces of said insulting layer. The insulating layer may further comprise additives to adjust the mechanical and/or electrical properties of the insulating layer.

In yet another embodiment, a first electric connection extends into a first conducting layer and a second electric connection extends into a second conducting layer. This allows for an electric connectivity of each light unit with each other. The conducting layers may be applied in the form of a coating. Also, the conducting layers may take the form of a fabric or a plastic film comprising electrically conductive material, such as metal wires. Said fabric may be a woven fabric or a nonwoven, preferably a woven fabric.

In another embodiment, a first set of electric connections are connected with each other to form a first electrically connected grid, and a second set of electric connections are connected with each other to form a second electrically connected grid. Accordingly, the electric grids may be formed as electric conduits which allow for connectivity of each light unit to an electric grid and allow for a reduced use of material as compared to the conducting layers. The electric connections may be provided onto said insulating layer by means of coating or more preferably by means of printing, i.e. to form a printed circuit board. The electric connections may be comprised of an electrically conductive material, such as an electrically conductive polymer material or may be comprised of a polymeric material comprising electrically conductive particles or fibres, i.e. copper particles or copper fibres.

In one embodiment, the covering panel is sideways (along the side edges of the panel) provided, preferably printed, with a first conductive film to cover said first conducting layer, and provided, preferably printed, with a second conductive film to cover said second conducting layer. Providing an additional conductive film sideways of each conducting layer allows to provide a larger contact surface and improve contact between conductive layers of neighbouring panels. As such, a better performance of a set of covering panels may be attained. In another embodiment, the electrically conducting layer may be coated with an electrically conductive polymer to improve electric contact between neighbouring panels.

In one embodiment, the first and/or said second conducting layer comprise a curable gel, preferably a UV curable gel. During installation, the gels of neighbouring panels may contact with each other to provide a better electric contact. Subsequently, the gels may be cured, i.e. by heat, but preferably by UV light, to provide one or two distinct layers of electrically conductive polymers over a plurality of covering panels. UV curing gels are preferred since the amount of heat applied and/or dissipated in the covering panel is limited.

5. Other Embodiments

5.1 Reinforcing Layer

The covering panel according to the present invention, may comprise a reinforcing layer. The reinforcing layer may be positioned between the top layer and the lighting system, or between the lighting system and the substrate. This is advantageous since said reinforcing layer provides mechanical strength and dimensional stability to the covering panel. Such improved mechanical strength and dimensional stability positively affects the stability of the electric network that provides electric connectivity between the plurality of light units, especially in the case of printed electric connections.

Said reinforcement layer can be achieved by extrusion of reinforcement fibres in a synthetic material and/or by providing a polymer-impregnated glass fibre fabric, preferably comprising a transparent or at least partially translucent polymer material, i.e. a polyvinyl chloride (PVC) material. Additionally, a reinforcing layer, i.e. an impregnated glass fibre fabric, may be provided on the bottom surface of the substrate. This reinforcement layer can have the function of enhancing the dimensional stability to the final covering panel, to prevent an excessive shrinkage or expansion due to a change of temperature and to improve the stability of the panel against local pressure by a sharp object, i.e., a piece of furniture. In one embodiment, said polymer-impregnated glass fibre fabric can have a surface weight of about 250 gsm to 600 gsm, and more preferably of about 350 gsm to 500 gsm. The glass fibre may be pre-treated with an adhesion additive, which is intended to improve the adhesion between said glass fibres and said thermoplastic matrix.

Preferably, said reinforcement fibres are comprised in said resilient layer in a quantity of between 1 and 25 wt. %, and more preferably between 5 and 15 wt. %. Preferably, said fibres meet the description according to the DIN 1259 standard.

5.2 Locking System

The covering panel according to the present invention may further comprise a locking system. The locking system comprises coupling parts for assembling several panels together. Coupling mechanisms have been widely used for many years and are well known to the artisan. Most popular coupling parts are glueless locking systems where both horizontal and vertical locking of the panels are realised with a tongue along one (edge) side and a groove along the opposite (edge) side of the panel. Typically tongue and groove locking systems are integrally made with the panel. An alternative locking system comprises a plurality of staggered hooking tongues, extending outwardly from the edges of the panel. Such a system is for example described in European patent application number 14164155.5, assigned to BerryAlloc NV.

The locking system may further provide a connection between respective conductive layer of the two or more neighbouring layers. I.e., an electrically conductive strip can be provided which, when introduced between two panels, induces a mechanical stress between the two neighbouring panels, thus providing a good mechanical interlocking, while also providing electric conductivity between the respective conductive layers.

### EXAMPLES

In the following examples are intended to further clarify the present invention, and are nowhere intended to limit the scope of the present invention.

### Example 1

A covering panel according to the invention can be obtained by providing an electrically insulating, foamed PVC panel with a series of recesses for providing one LED in each single recess. At the bottom of each recess, an opening is provided to allow for an electric connection to the opposite surface of the substrate. Said opposite surface is then provided with a thin metallic film to allow for an electric connection between the first poles of the series of LEDs. On the top surface, said substrate is coated with a continuous film of a translucent polymer material comprising copper fibres. The thin metallic film and the electrically conductive polymer layer can be connected to opposing poles of an electric source.

The top surface is then glued and provided with a translucent paper. To protect said translucent paper against incident damages, a wear layer is provided. A locking system of the type comprising a tongue and groove is provided in the side surfaces of the substrate. The locking system is dimensioned to allow a good contact between the respective conductive layers.

To ensure that the covering exhibits a minimal amount of flexibility upon indention, a resilient backing layer is provided on the rear surface of the covering panel. Said backing layer is comprised of a soft PVC foam with a density of about 360 gsm and a thickness of about 0.35 mm.

### Example 2

A foamed PVC panel comprising locking means is provided with a flat top surface. Said top surface is then provided with a thin metallic film to allow for electric conductivity. A series of spatially separated UV-curable OLED films are than printed on the top surface of said PVC panel and cured using UV light. Upon curing of the OLED films, an electrically insulating layer is coated between said OLED films to provide electric insulation of the two electric poles of the OLEDs. Next, a grid of a transparent, electrically conductive polymer is printed on top of the OLEDs and the electrically insulating layer. In an alternative embodiment, a full coating of electrically conductive material is provided. The thin metallic film and the electrically conductive polymer layer can be connected to opposing poles of an electric source.

On top of the electrically conductive polymer, a décor is provided by digital printing of a variegated image. Subsequently, a wear layer comprising PVC with aluminium particles is coated on top of the décor to ensure wear resistance of the covering panel. To provide a good visual aspect, a UV-curable polyurethane layer is further provided and embossed in register before curing.

1. A covering panel, such as a floor covering panel, a wall covering panel or a ceiling covering panel, comprising:
i. a top layer,
ii. a substrate, and
iii. a lighting system comprising a plurality of light units wherein the lighting system is situated between said top layer and said substrate.

2. A covering panel according to claim 1, whereby said light units are light emitting diodes (LEDs).

3. A covering panel according to claim 2, whereby said top layer comprises a décor provided on top of said lighting system.

4. A covering panel according to claim 3, wherein said décor is printed by means of a digital printer.

5. A covering panel according to claim 1, whereby said substrate comprises a plurality of cavities for hosting a plurality of light units.

6. A covering panel according to claim 5, whereby said substrate comprises at least two sets of a plurality of conduits between said plurality of cavities for providing electric connectivity between said plurality of hosted light units.

7. A covering panel according to claim 1, comprising a reinforcing layer between said top layer and said lighting system.

8. A covering panel according to claim 1, whereby said light units are provided within an insulating layer.

9. A covering panel according to claim 8, whereby said light units have a first electric connection protruding from a first surface of said insulating layer and a second electric connection protruding from a second surface of said insulating layer.

10. A covering panel according to claim 9, whereby said first electric connection extends into a first conducting layer and a second electric connection extends into a second conducting layer.

11. A covering panel according to claim 9, whereby a first set of electric connections are connected with each other to form a first electrically connected grid, and whereby a second set of electric connections are connected with each other to form a second electrically connected grid.

12. A covering panel according to claim 10, whereby said covering panel is provided along its side edges, preferably printed, with a first conductive film to cover said first conducting layer, and provided, preferably printed, with a second conducting film to cover said second conductive layer.

13. A covering panel according to claim 10, whereby said first and/or said second conductive layer comprise a curable gel, preferably a UV curable gel.

14. A covering panel according to claim 1, whereby said substrate is provided with a locking system.
